(19) United States
(12) Patent Application Publication
(10) Pub. No.: US 2024/0284586 A1
(43) Pub. Date: Aug. 22, 2024

(54) MICROWAVE COUPLER FOR ELECTRON CYCLOTRON RESONANCE ACCELERATOR

(71) Applicant: Omega-P R&D, Inc., New Haven, CT (US)

(72) Inventor: Yong JIANG, New Haven, CT (US)

(21) Appl. No.: 18/443,900

(22) Filed: Feb. 16, 2024

Related U.S. Application Data
(60) Provisional application No. 63/485,591, filed on Feb. 17, 2023.

(51) Int. Cl. H05H 7/16; H01P 3/12; H05H 13/00

(52) U.S. Cl. CPC H05H 7/16; H01P 3/12; H05H 13/005

(57) ABSTRACT

Apparatuses and methods for accelerating electrons include a radio-frequency (RF) waveguide configured to couple an RF source to an accelerator that utilizes electron cyclotron resonance acceleration (eCRA). The RF waveguide includes a pair of parallel rectangular waveguides including a first waveguide and a second waveguide and a mode converter coupled to respective ends of the pair of parallel rectangular waveguides. The mode converter includes and outer body and two coaxial cylinders. An electron source is configured to provide a beam of electrons through an inner cylinder. An accelerator includes a RF cavity having a longitudinal axis, a cylindrical outer wall, an inlet, and an outlet and an electro-magnet surrounding the RF cavity and configured to produce an axial magnetic field. The mode converter is configured to excite a rotating TE-111 mode in the RF cavity.

### CROSS-REFERENCE TO RELATED APPLICATION

The present application claims benefit of U.S. Provisional Application No. 63/485,591 entitled “IMPROVED MICROWAVE COUPLER FOR ELECTRON CYCLOTRON RESONANCE ACCELERATOR” filed Feb. 17, 2023, and is assigned to the assignee hereof and hereby expressly incorporated by reference herein.

### STATEMENT REGARDING GOVERNMENT SUPPORT

The Government has rights in this invention pursuant to a USER Agreement dated Oct. 6, 2022 between Particle Accelerated Research Foundation (PARF) and BROOKHAVEN SCIENCE ASSOCIATES, LLC, which manages and operates Brookhaven National Laboratory for the US Department of Energy under Contract No. DE-SC0012704.

### TECHNICAL FIELD

Aspects of the present disclosure generally relate to apparatuses and methods for accelerating electrons.

### BACKGROUND

Energetic charged particles have many usage applications in the fields of medicine, nuclear energy, testing, experimental research, national security, etc. Examples of energetic charged particles include ions, protons, electrons, and positrons. Conventional equipment used in producing energetic charged particles may require high investment cost and large facilities or real estate, while limiting the mobility of the equipment. Therefore, there continue to be unmet needs for improvements in the production of energetic charged particles.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In some aspects, the techniques described herein relate to a radio-frequency (RF) waveguide including: a pair of parallel rectangular waveguides including a first waveguide and a second waveguide; and a mode converter coupled to respective ends of the pair of parallel rectangular waveguides, the mode converter including two coaxial cylinders.

In some aspects, the techniques described herein relate to a RF waveguide, wherein a first waveguide of the pair of parallel rectangular waveguides is configured to feed microwaves from an RF source into the mode converter.

In some aspects, the techniques described herein relate to a RF waveguide, wherein a second waveguide of the pair of parallel rectangular waveguides is coupled to an RF load.

In some aspects, the techniques described herein relate to a RF waveguide, wherein the mode converter is configured to transform a radiation pattern into a rotating TE-11 coaxial mode between the two coaxial cylinders.

In some aspects, the techniques described herein relate to a RF waveguide, wherein the mode converter includes an outer body having at least a first transverse inward projection in an outer wall between one of the rectangular waveguides and an outer cylinder of the two coaxial cylinders.

In some aspects, the techniques described herein relate to a RF waveguide, wherein the two coaxial cylinders of the mode converter extend axially past the outer body and the pair of parallel rectangular waveguides.

In some aspects, the techniques described herein relate to a RF waveguide, wherein the outer body of the mode converter includes an axial inward projection opposite the two coaxial cylinders.

In some aspects, the techniques described herein relate to an apparatus including: a radio-frequency (RF) waveguide including: a pair of parallel rectangular waveguides including a first waveguide and a second waveguide; and a mode converter coupled to respective ends of the pair of parallel rectangular waveguides, the mode converter including and outer body and two coaxial cylinders; an electron source configured to provide a beam of electrons; and an accelerator including: a RF cavity having a longitudinal axis, a cylindrical outer wall, an inlet, and an outlet; an electro-magnet surrounding the RF cavity and configured to produce an axial magnetic field.

In some aspects, the techniques described herein relate to an apparatus, wherein the inlet of the RF cavity is configured to receive the beam of electrons through an inner cylinder of the two coaxial cylinders.

In some aspects, the techniques described herein relate to an apparatus, wherein the mode converter is configured to transform a radiation pattern into a rotating TE-11 coaxial mode between the two coaxial cylinders.

In some aspects, the techniques described herein relate to an apparatus, wherein the mode converter is configured to excite a rotating TE-111 mode in the RF cavity.

In some aspects, the techniques described herein relate to an apparatus, wherein a first waveguide of the pair of parallel rectangular waveguides is configured to feed microwaves from the RF source into the mode converter.

In some aspects, the techniques described herein relate to an apparatus, wherein a second waveguide of the pair of parallel rectangular waveguides is coupled to an RF load.

In some aspects, the techniques described herein relate to an apparatus, wherein the mode converter includes at least a first transverse inward projection in an outer wall of the outer body between one of the rectangular waveguides and an outer cylinder of the two coaxial cylinders.

In some aspects, the techniques described herein relate to an apparatus, wherein the two coaxial cylinders of the mode converter extend axially past the pair of parallel rectangular waveguides.

In some aspects, the techniques described herein relate to an apparatus, wherein the outer body of the mode converter includes an axial inward projection opposite the two coaxial cylinders.

In some aspects, the techniques described herein relate to an apparatus, wherein the cylindrical outer wall of the RF cavity is free of openings.

In some aspects, the techniques described herein relate to a method, including: feeding, via an RF waveguide, microwaves from an RF source into a mode converter including and outer body and two coaxial cylinders, the mode converter configured to transform a radiation pattern of the microwaves into a rotating TE-11 coaxial mode between the two coaxial cylinders; exciting, by the mode converter, a rotating TE-111 mode in an RF cavity coupled to respective ends of the two coaxial cylinders; generating an axial magnetic field in the RF cavity with a first magnet surrounding the RF cavity; emitting a beam of electrons into the RF cavity through a passage within an inner cylinder of the two coaxial cylinders; and accelerating the beam of electrons axially entering the RF cavity with non-linear cyclotron resonance acceleration.

In some aspects, the techniques described herein relate to a method, further including manipulating the beam of electrons leaving the RF cavity into a desired beam shape with a second magnet.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The features of various aspects of the disclosure are set forth in the appended claims. In the description that follows, like parts are marked throughout the specification and drawings with the same or similar numerals, respectively. The drawing figures are not necessarily drawn to scale, and certain figures may be shown in exaggerated or generalized form in the interest of clarity and/or conciseness. The disclosure itself, however, as well as a preferred mode of use, further advantages thereof, will be best understood by reference to the following detailed description of illustrative aspects of the disclosure when read in conjunction with the accompanying drawings.

FIG. 1 is schematic diagram illustrates some components of an electron cyclotron resonance acceleration (eCRA) system in accordance with aspects of the present disclosure.

FIG. 2 is a diagram of an example eCRA system including a coupler between an RF waveguide and a radio-frequency (RF) cavity in accordance with aspects of the present disclosure.

FIG. 3 is a diagram of some components of the system of FIG. 2 in accordance with aspects of the present disclosure.

FIG. 4 is a perspective view of the coupler in accordance with aspects of the present disclosure.

FIG. 5A shows a side view of the coupler in accordance with aspects of the present disclosure.

FIG. 5B shows a front view of the coupler in accordance with aspects of the present disclosure.

FIGS. 6A-6C show simulated RF fields in the coupler in accordance with aspects of the present disclosure.

FIGS. 7A-7C are diagrams of examples of electron paths in an eCRA system forming an annular beam that impinges an x-ray converter in accordance with aspects of the present disclosure.

FIG. 8 is a flowchart of an example method for accelerating electrons in accordance with aspects of the present disclosure.

FIG. 9 illustrates an example of a computer system for controlling an eCRA system in accordance with aspects of the present disclosure.

FIG. 10 illustrates a block diagram of various exemplary system components, in accordance with aspects of the present disclosure.

### DETAILED DESCRIPTION

The following includes definitions of selected terms employed herein. The definitions include various examples and/or forms of components that fall within the scope of a term and that may be used for implementation. The examples in the description are not intended to be limiting.

Development of compact, efficient, low-cost, high-power electron accelerators is needed for scientific, national security, industrial, and commercial applications. Typically, these accelerators produce beams with average powers up to 100 kW although above, and particle energies of up to 10 MeV—a limit that is often imposed to minimize activation, neutron production, and shielding mass. In an aspect, it may be desirable for applications with greater power. Applications for MW-level beam powers exist for remediation of polluted wastewater streams, flue gas and other effluents; neutralization of toxic solid wastes; and numerous industrial processes. Lower power applications are in bremsstrahlung (“braking radiation”) sources for sterilization of medical instruments and supplies, foodstuffs, and photonuclear reactions to produce radioisotopes, and for production of intense THz radiation.

One candidate for an industrial accelerator designed to meet these needs for some of these applications is electron cyclotron resonance acceleration (eCRA), described in International Application No. PCT/US/22/40457, which is assigned to the assignee hereof and incorporated herein by reference. The eCRA provides for an alternate concept for cyclotron resonance acceleration of electrons that employs a cavity (e.g., a cylindrical cavity) operating under conditions that do not conform to auto-resonance. Accordingly, performance of an accelerator according to this alternate concept can exceed limits imposed by the auto-resonance condition. The radio-frequency (RF) fields of the cavity are a superposition of two orthogonal modes excited in quadrature to provide a rotating standing-wave mode. The detailed numerical solutions of the highly non-linear equations that govern motion for electrons injected into a TE₁₁₁-mode cavity immersed in a strong axial magnetic field show power beyond the intrinsic limit of previous accelerators. These higher energy limits arise when slippage in phase between the particle's momentum and the RF electric field moves from accelerating into decelerating ranges, or by particle interception on the cavity wall. The slippage in phase favors energy transfer to the electrons and avoids energy transfer back to the RF wave.

Generally, an eCRA system includes an electron source configured to provide a beam of electrons and an accelerator. The accelerator includes an RF cavity having a longitudinal axis, one or more inlets, and one or more outlets. The accelerator includes an electro-magnet substantially surrounding at least a portion of the cavity and configured to produce an axial magnetic field. The accelerator includes at least one pair of waveguides coupling the RF cavity to an RF source configured to generate a RF wave. The RF wave is a superposition of two orthogonal TE₁₁₁ transverse electric modes excited in quadrature to produce an azimuthally rotating standing-wave mode configured to accelerate the beam of electrons axially entering the cavity with non-linear cyclotron resonance acceleration.

The eCRA system described in International Application No. PCT/US/22/40457 includes a waveguide assembly that conveys microwave energy from the RF source (typically a klystron) to the eCRA accelerator cavity within the magnetic field coils. The goal of exciting the eCRA cavity in spatiotemporal quadrature results in complexity in the design of waveguides. In some implementations, the waveguides include two “antler” waveguides that excite the eCRA cavity in spatiotemporal quadrature. In one implementation, an S-band eCRA demonstrator test stand includes a Canon E3730A klystron (positioned outside of the test bunker) and a WR-284 waveguide circuit that includes directional couplers, a variable power divider, and a 3-dB hybrid to split the power equally with a 90° phase difference into the “antlers” that drive the eCRA cavity. This arrangement has been proven effective in laboratory experiments, but leaves room for improvement in terms of simplicity and compactness. For example, the location of the waveguides may affect a quality factor (Q) of the RF cavity and may limit positioning of the magnets with respect to the eCRA cavity. An eCRA that is more compact, portable, robust, efficient, and/or of moderate cost would be desirable.

In an aspect, the present disclosure provides a microwave coupler that connects a pair of parallel waveguides to an eCRA cavity. The microwave coupler is a mode converter including two coaxial cylinders. The mode converter is configured to transform a radiation pattern from at least one of the waveguides into a rotating TE-11 coaxial mode between the two coaxial cylinders. The mode converter may be coupled to an end of the eCRA cavity to excite a rotating TE-111 mode in the eCRA cavity. In an aspect, coupling the coaxial cylinders to an end of the eCRA cavity allows the cylindrical wall of the eCRA cavity to be free of openings, which may lower the cavity quality factor Q, and thereby increase the RF power level needed to afford a given amount of electron beam acceleration. Further, the beam of electrons may be emitted into the eCRA cavity through a passage created by the inner cylinder of the mode converter. The beam of electrons is shielded from RF fields until entering the eCRA cavity. Additionally, the coupling simplifies design of the magnet, which does not need to accommodate antler waveguides connected to the eCRA cavity.

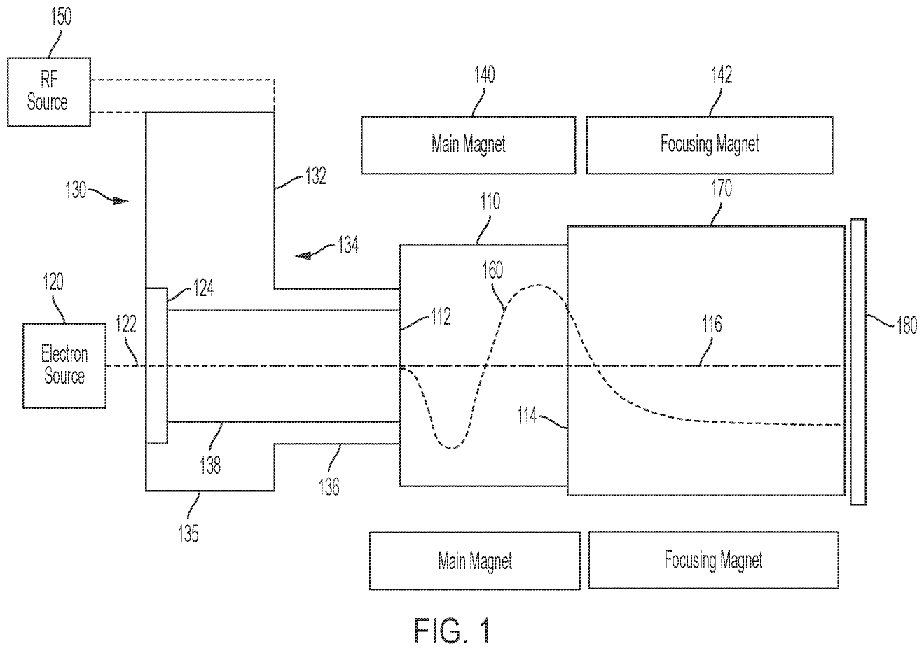

Turning to FIG. 1, schematic diagram illustrates some components of an eCRA system 100. The system 100 (i.e., an apparatus) includes an RF cavity 110, which may also be referred to as an eCRA cavity. For example, the RF cavity 110 may be a cylindrical cavity having a radius R and length L. The RF cavity 110 may have a longitudinal axis 116. In various implementations, the longitudinal axis 116 may be oriented vertically or horizontally. The RF cavity 110 includes one or more inlets 112 and one or more outlets 114. The direction along the longitudinal axis 116 from the inlet 112 to the outlet 114 may be referred to as the axial direction or the downstream direction. Additionally, an end closes to an electron source 120 may be referred to as proximal, and an end furthest from the electron source may be referred to as distal. In some implementations, the RF cavity 110 is made of copper. In some implementations, the eCRA system 100 operates at room temperature. As used herein, “room temperature” refers to temperatures that do not cause the RF cavity 110 to be super-conductive. In some implementations, for example, the RF cavity 110 may be cooled by water or another suitable fluid. For instance, the RF cavity 110 may be cooled to within 0°-100° C., or preferably 20°-80° C. For example, in some implementations, the RF cavity 110 may include channels for cooling with a suitable fluid (e.g., water, forced air, or forced Helium gas).

In an aspect, the system 100 includes a coupler 130 for coupling the RF cavity 110 to an RF source 150. The coupler 130 includes waveguides 132 and a mode converter 134. The waveguides 132 may include a pair of parallel rectangular waveguides. For instance, the waveguides 132 may be connected coupled to the RF source 150 (e.g., a klystron) via a waveguide circuit including one or more directional couplers, variable power dividers, hybrids, or RF loads. For instance, one of the (vertically shown) rectangular waveguides 132, for example WR-284 for S-band operation, feeds microwaves from the RF source 150. The second waveguide 132, parallel to the first, is to balance the symmetry of the mode converter 134 and transmit residual reflected power up to a matched waveguide load. The waveguide load can be designed to also serve as a vacuum pump-out port. The mode converter 134 may be coupled to respective ends of the waveguides 132. For example, in some implementations, the coupler 130 may be an integrated unit in which the mode converter 134 is permanently attached to the waveguides 132. For instance, the coupler 130 may be formed by casting, welding, or additive manufacturing.

The mode converter 134 includes an outer body 135 and two coaxial cylinders: an outer cylinder 136 and an inner cylinder 138. The mode converter 134 is configured to transform a radiation pattern in the waveguides 132 into a rotating TE-11 coaxial mode between the two coaxial cylinders. The waveguides 132 may connect to the mode converter 134 at an upstream end proximal to the electron source 120. The inner cylinder 138 may extend through the mode converter 134 and serve as an inner wall forming a cylindrical passage through the mode converter 134. The waveguides 132 feed RF radiation into the space between the inner cylinder and the outer wall of the mode converter 134 including the outer body 135 and the outer cylinder 136. In some implementations, the mode converter 134 includes projections 124 in the outer cylinder 136 and/or the inner cylinder 138 that guide the RF radiation into the rotating TE-11 coaxial mode.

The system 100 includes an electron source 120 configured to provide a beam of electrons 122. For example, the electron source 120 may be an electron gun or electron emitter. The electron source 120 is aligned with the inner cylinder 136 to axially inject the beam of electrons 122 into cylindrical passage formed by the inner cylinder 136. The coaxial arrangement of the mode converter 134 allows the low energy injected beam of electrons 122 to be transported into the RF cavity 110 within the inner cylinder 136. This arrangement also has the advantage of not requiring openings in the cylindrical wall of the RF cavity 110 for feeding RF power from the waveguides,

The system 100 includes a first magnet 140 that substantially surrounds at least a portion of the cavity 110. In some implementations, the first magnet 140 may include two or more coils. The first magnet 140 may be a superconducting electro-magnet, an electro-magnet, a permanent magnet, and/or an electro-permanent magnet. The magnet 140 may include structures such as plates or bars to shape a magnetic field. The magnet 140 may be cooled to a critical temperature, or below, as needed for use and/or operation of any superconducting materials inside the magnet 140. The magnet 140 may include materials such as niobium titanium, niobium tin, vanadium gallium, magnesium diboride, bismuth strontium calcium copper oxide, yttrium barium copper oxide, and/or other suitable materials. In some implementations, the magnetic field strength of the magnet 140 may be 0.7 Tesla or less, where room temperature coils may operate. In other applications magnets with 1 Tesla, 2 Tesla, 5 Tesla, 7 Tesla, 10 Tesla, or other suitable field strength may be utilized.

In some implementations, the magnet 140, or additional magnets may extend past the cavity 110 and control the accelerated electrons. In an aspect, the beam of electrons 122 enters the cavity 110 and the electrons are accelerated with non-linear cyclotron resonance acceleration. For example, the electrons may follow a path 160, which traces a circular helical pattern about a respective axis when the magnetic field is constant. It was found, depending on the RF-field strength (as characterized by E_{w}) and the magnitude of the guide magnetic field Bₒ, that electrons are accelerated, but can either reach and are transmitted through the end wall of the cavity 110, or can be reflected back. The walls of the idealized cavity are taken to be transparent to electrons.

In an aspect, the system 100 includes a second magnet 142 that substantially surrounds at least a portion of a beam channel 170. In some implementations, the first magnet 140 extends past the RF cavity 110 to surround a portion of the beam channel 170. The beam channel 170 may be a hollow cylindrical member. In an aspect, the RF field does not extend into the beam channel 170. The second magnet 142 provides a second magnetic field that interacts with the magnetic field of the first magnet 140 to manipulate the beam of electrons leaving the RF cavity 110. For example, the second magnet 142 may cause the electrons to converge, diverge, or travel linearly toward a target 180.

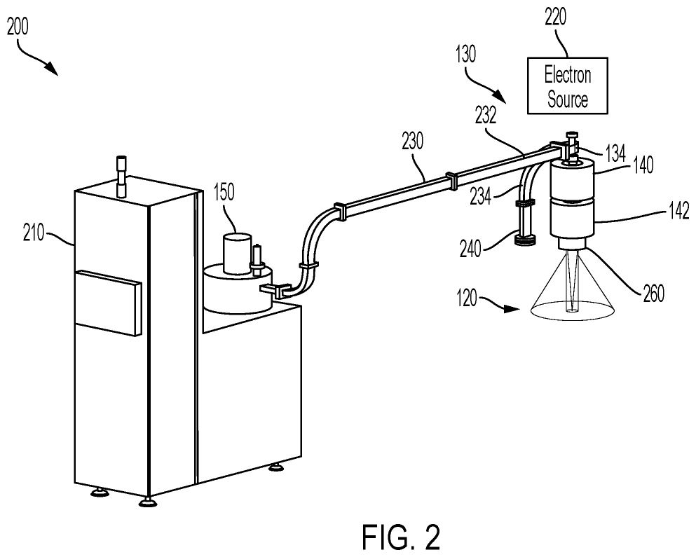

FIG. 2 is a diagram of an example eCRA system 200 including the coupler 130. The eCRA system 200 may be arranged vertically to direct an accelerated beam of electrons or x-rays downwards.

The eCRA system 200 includes an RF source 150 (e.g. a klystron such as an XK-5 klystron.). The RF source 150 may be controlled via a modulator 210. A waveguide 230 feeds microwaves from the RF source 150 to the coupler 130. A first waveguide 232 of the coupler 130 feeds the microwaves to the mode converter 134. The second waveguide 234, parallel to the first waveguide 232, is to balance the symmetry of the mode converter 134 and transmit residual reflected power up to a matched waveguide load 240. The waveguide load 240 can be designed to also serve as a vacuum pump-out port. In an implementation, the RF components are S-band components (e.g., 2.856 GHz). For example, the waveguide circuit may be a WR-248 waveguide circuit

The electron source 220 may be an e-gun tank. As discussed above, the electron source 220 may emit electrons into the cylindrical passage through the mode converter 134. The first magnet 140 surrounds the RF cavity. The second magnet 142 allows for manipulation of the beam of accelerated electrons until the beam impinges on an x-ray converter 260 and e-beam dump. For example, the x-ray converter may include a target of a heavy metal that emits x-rays when struck by the accelerated electrons. Manipulation of the beam of accelerated electrons via the second magnet 142 allows generation of a focused, parallel, or spread beam of x-rays.

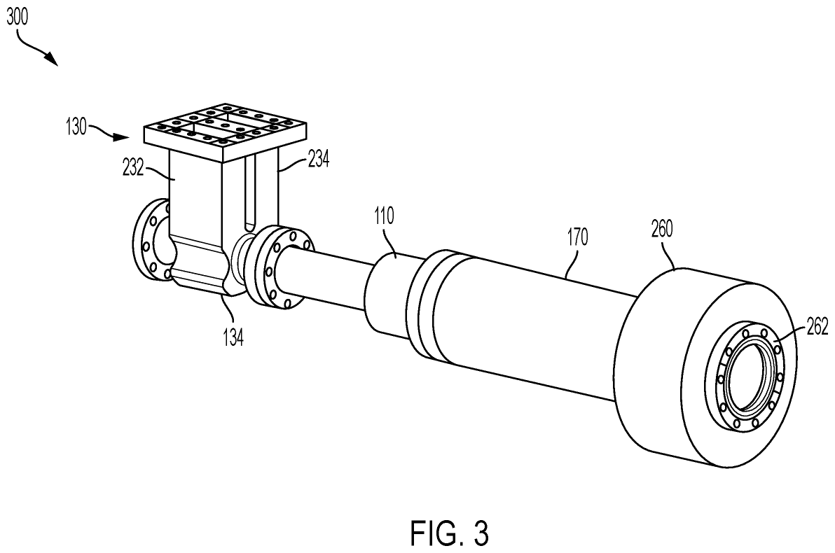

FIG. 3 is a diagram 300 of some components of the eCRA system 200 including the coupler 130, the RF cavity 110, the e-beam manipulation channel 170, and the x-ray converter 260.

The outer cylindrical wall of the RF cavity 110 may be a solid wall free of openings. The coupling the mode converter 134 to the distal end of the RF cavity eliminates a need for openings in the outer cylindrical wall of the RF cavity 110. The solid wall improves the quality factor Q, and thereby decreases the RF power level needed to afford a given amount of electron beam acceleration. That is, the solid outer cylindrical wall improves energy efficiency of the eCRA system 200. Further, the lack of RF waveguides coupled to the outer cylindrical wall of the RF cavity 110 simplifies design of the first magnet 140.

The x-ray converter 260 may include the target 180 (FIG. 1). The x-ray converter generates a beam of x-rays when the accelerated beam of electrons impinges the target 180, which may be a heavy metal. The x-ray converter 260 includes an x-ray window 262, which allows x-rays to pass and also seals a vacuum of the eCRA system 200. The x-ray converter 260 may also serve as a spent e-beam dump.

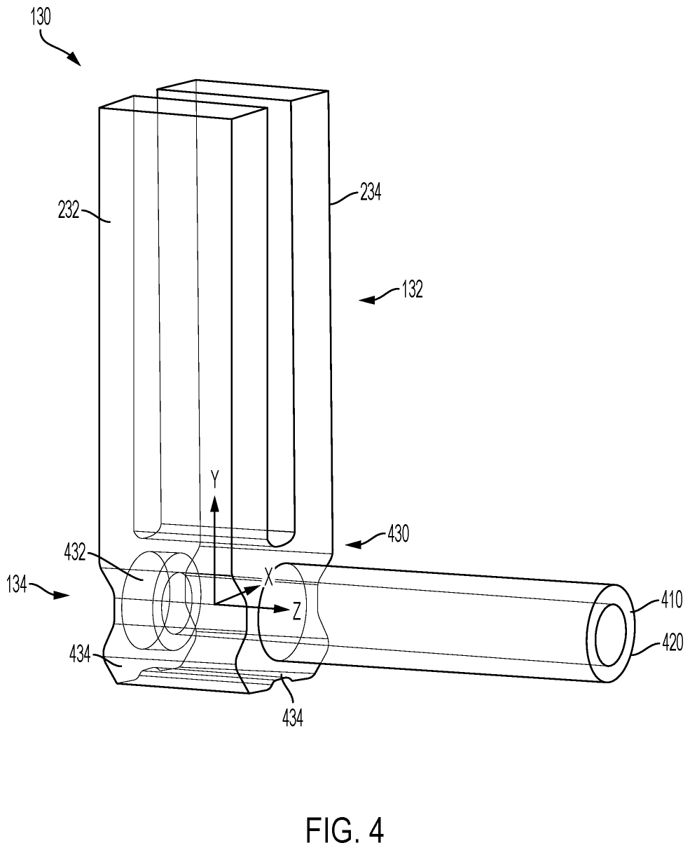

FIG. 4 is a perspective view of the coupler 130. The first waveguide 232 and the second waveguide 234 extend in parallel to the mode converter 134. The mode converter 134 includes two coaxial cylinders: an outer cylinder 410 and an inner cylinder 420. The mode converter 134 includes a body 430 that extends around the inner cylinder 420. The outer cylinder 410 extends downstream from the body 430. The body 430 and the outer cylinder 410 form a cavity around the inner cylinder 420. The body 430 includes an axial protrusion 432 into the cavity. The axial protrusion 432 directs the microwaves downstream. The body 430 also includes transverse protrusions 434 that extend inward toward the inner cylinder 420. The transverse protrusions 434 direct the microwaves in a helical pattern.

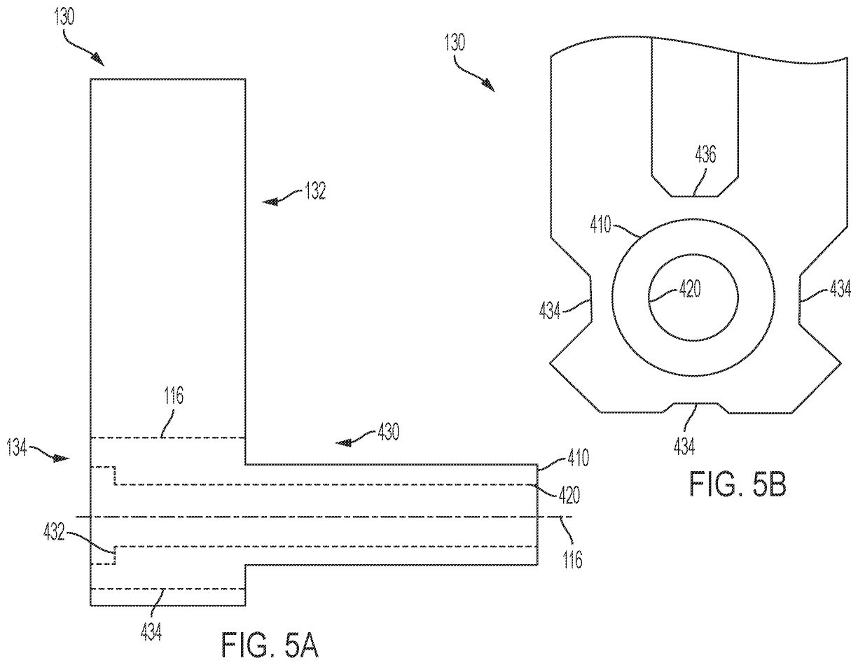

FIG. 5A shows a side view of the coupler 130. FIG. 5B shows a front view of the coupler 130. The longitudinal axis 116 is the axis of the coaxial cylinders: outer cylinder 410 and an inner cylinder 420. The axial protrusion 432 is illustrated as a disc; however, other annular shapes may be used. The lower transverse protrusion may be symmetric with a wall 436 of the body 430 between the waveguides 132.

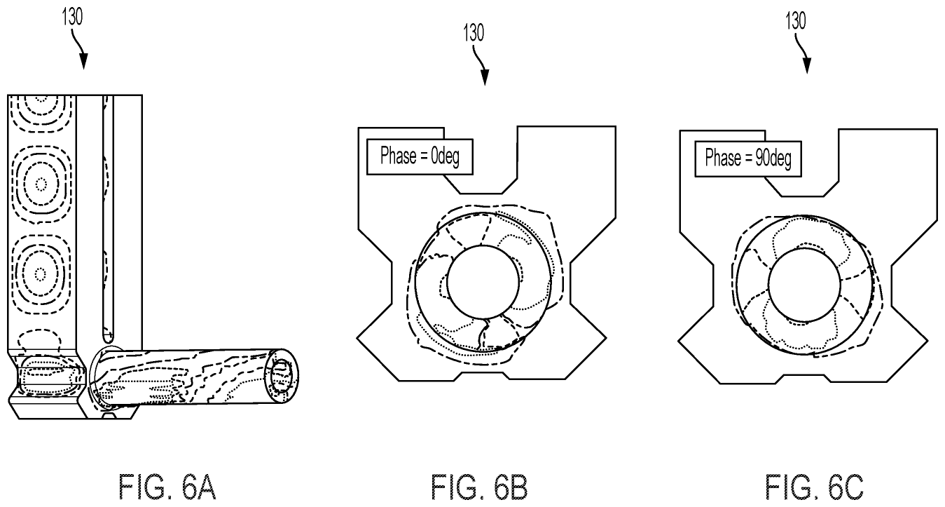

FIGS. 6A-6C show simulated RF fields in the coupler 130. In FIG. 6A, the simulated RF fields in the coupler have a helical character. For example, the microwaves entering via one of the waveguides 132 results in a rotating character around the inner cylinder 420. The axial protrusion 432 induces an axial component. In FIG. 6B and 6C the simulated RF fields, showing in the coaxial waveguide for 0 degrees and 90 degrees in phase how the fields have rotated. It is this rotating character of the fields in the coaxial waveguides of the coupler 130 that effectively to excite a rotating TE-111 mode in the eCRA cavity that is necessary for eCRA acceleration.

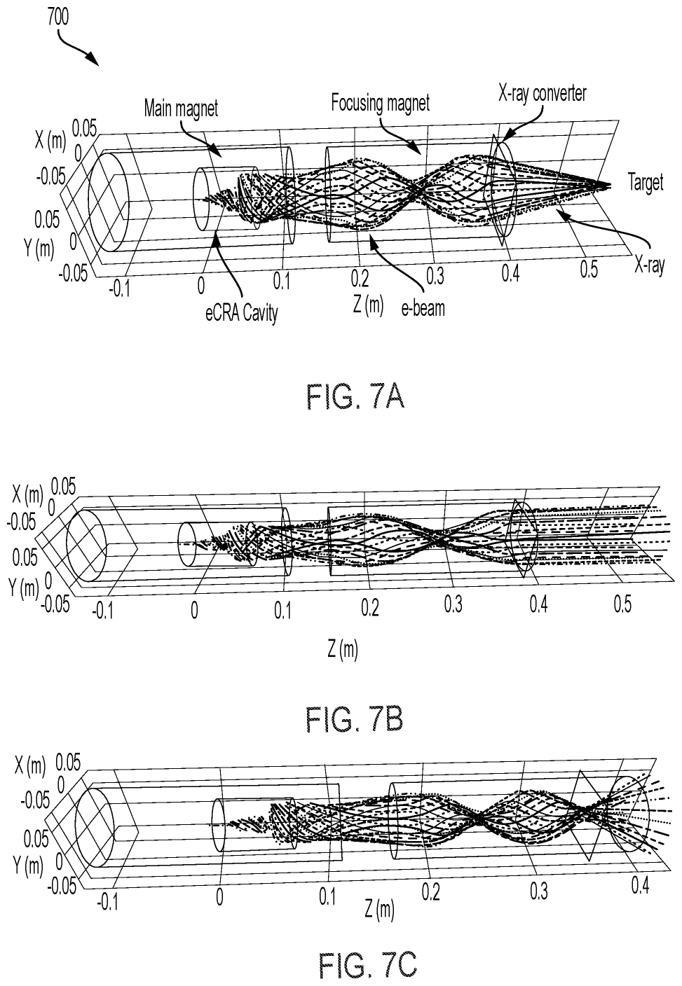

FIGS. 7A-7C are diagrams of examples of electron paths in an eCRA system forming an annular beam that impinges an x-ray converter 260. The x-ray converter 260 may be a heavy metal such as tungsten (W) or Tantalum (Ta) that absorbs the beam electrons. Via the Bremsstrahlung process, the heavy metal generates a forward-directed beam of energetic x-rays. The x-rays may be used, for example, for sterilization of food-stuffs or medical supplies. In FIG. 7A, the electrons impinge the x-ray converter 260 at a radially inward angle resulting in a focused beam of x-rays. In FIG. 7B, the electrons impinge the x-ray converter 260 at a substantially linear path resulting in parallel beams of x-rays in a circular pattern. In FIG. 7C the electrons impinge the x-ray converter at a radially outward angle resulting in a diverging beam of x-rays. Further details of manipulating the beam of electrons are described in Applicant's co-pending U.S. application Ser. No. 18/428,788 titled “DEVICES AND METHODS FOR MANIPULATING BEAMS FROM AN ELECTRON CYCLOTRON RESONANCE ACCELERATOR” filed Jan. 31, 2024, which is incorporated herein by reference.

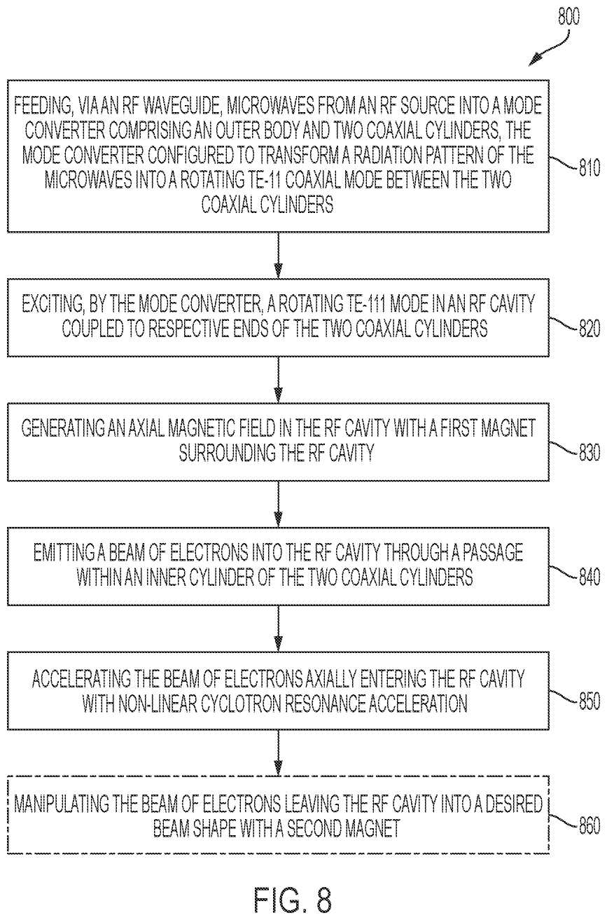

Turning now to FIG. 8, a flowchart of an example method 800 for accelerating electrons may be performed by the eCRA system 100 (FIG. 1) or the eCRA system 200 (FIG. 2), for example.

At block 810, the method 800 may include feeding, via an RF waveguide, microwaves from an RF source into a mode converter comprising and outer body and two coaxial cylinders, the mode converter configured to transform a radiation pattern of the microwaves into a rotating TE-11 coaxial mode between the two coaxial cylinders. For example, the RF source 150 may feed microwaves into the waveguide 230 connected to the first waveguide 232 then into the mode converter 134. The mode converter 134 is configured to transform a radiation pattern of the microwaves into a rotating TE-11 coaxial mode between the two coaxial cylinders.

At block 820, the method 800 may include exciting, by the mode converter, a rotating TE-111 mode in an RF cavity coupled to respective ends of the two coaxial cylinders. For example, the mode converter 134 may be coupled to the RF cavity 110 at respective ends of the two coaxial cylinders 136, 138. The TE-11 mode in the coaxial waveguide formed by the two coaxial cylinders excites a rotating TE-111 mode in the RF cavity 110.

At block 830, the method 800 may include generating an axial magnetic field in the RF cavity with a first magnet surrounding the RF cavity. For example, the first magnet 140 that surrounds the RF cavity 110 may generate the axial magnetic field in the RF cavity 110.

At block 840, the method 800 may include emitting a beam of electrons into the RF cavity through a passage within an inner cylinder of the two coaxial cylinders. For example, the electron source 120 may emit a beam of electrons 122 into the RF cavity 110 through a passage within the inner cylinder 138 of the two coaxial cylinders.

At block 850, the method 800 may include accelerating the beam of electrons axially entering the RF cavity with non-linear cyclotron resonance acceleration. For example, the magnetic field generated by the first magnet 140 and the rotating TE-111 mode in the RF cavity 110 may accelerate the beam of electrons 122 axially entering the RF cavity 110 with non-linear cyclotron resonance acceleration.

At block 860, the method 800 may optionally include manipulating the beam of electrons leaving the RF cavity into a desired beam shape with a second magnet. For example, the magnetic field generated by the second magnet 142 in the beam channel 170 may manipulate the beam of electrons leaving the RF cavity 110 into a desired beam shape.

Referring back to FIG. 1, the eCRA system 100 may include a computer system configured to automatically control the generation of accelerated charged electrons and/or various other features of the system 100, such as those used for one or more accelerated beams of electrons, via communication couplings. The communication couplings may be wired and/or wireless couplings, including Wireless Fidelity (WiFi) links, Blutooth links, General Purpose Interface Bus (GPIB) links, Parallel links, Serial links, Universal Serial Bus (USB) links, Peripheral Component Interconnect (PCI) link, or other suitable communication couplings.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

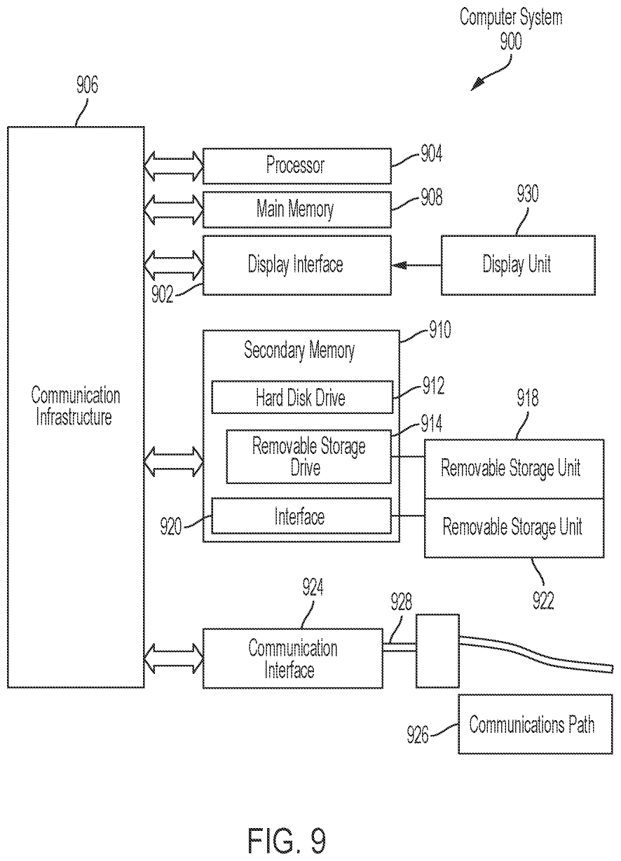

In an aspect of the present disclosure, features are directed toward one or more computer systems capable of carrying out the functionality described herein. An example of such the computer system 900 is shown in FIG. 9. The computer system 900 may include one or more processors, such as the processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

The computer system 900 may include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912, and/or a removable storage drive 914, representing a floppy disk drive, a magnetic tape drive, an optical disk drive, a universal serial bus (USB) flash drive, etc. The removable storage drive 914 reads from and/or writes to a removable storage unit 918 in a well-known manner Removable storage unit 918 represents a floppy disk, magnetic tape, optical disk, USB flash drive etc., which is read by and written to removable storage drive 914. As will be appreciated, the removable storage unit 918 includes a computer usable storage medium having stored therein computer software and/or data.

Alternative aspects of the present disclosure may include secondary memory 910 and may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, an RF link and/or other communications channels. In this document, the terms “computer program medium” and “computer usable medium” are used to refer generally to media such as a removable storage unit 918, a hard disk installed in hard disk drive 912, and signals 928. The term non-transitory computer-readable medium specifically excludes transitory signals. These computer program products provide software to the computer system 900. Aspects of the present disclosure are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features in accordance with aspects of the present disclosure, as discussed herein. In particular, the computer programs, when executed, enable the processor 904 to perform the features in accordance with aspects of the present disclosure. Accordingly, such computer programs represent controllers of the computer system 900.

In an aspect of the present disclosure where the method is implemented using software, the software may be stored in a computer program product and loaded into computer system 900 using removable storage drive 914, hard drive 912, or communications interface 920. The control logic (software), when executed by the processor 904, causes the processor 904 to perform the functions described herein. In another aspect of the present disclosure, the system is implemented primarily in hardware using, for example, hardware components, such as application specific integrated circuits (ASICs). Implementation of the hardware state machine so as to perform the functions described herein will be apparent to persons skilled in the relevant art(s).

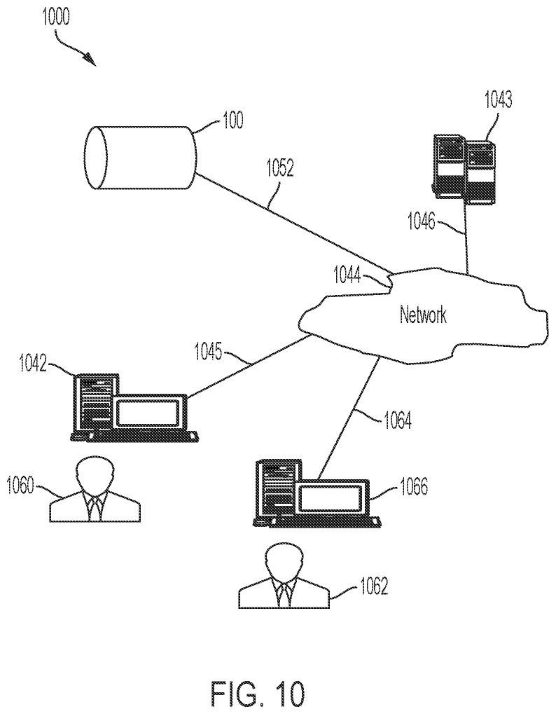

FIG. 10 illustrates a block diagram of various example system components for use with implementations in accordance with an aspect of the present disclosure. FIG. 10 shows a communication system 1000 usable in accordance with aspects of the present disclosure. The communication system 1000 includes one or more accessors 1060, 1062 (also referred to interchangeably herein as one or more “users”) and one or more terminals 1042, 1066. In one aspect, data for use in accordance with aspects of the present disclosure may, for example, be input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another example variation, the method and system in accordance with aspects of the present disclosure operate in a stand-alone environment, such as on a single terminal. In some aspects, the eCRA system 100 may be connected to the network 1044 via a coupling 1052. The data from the eCRA system 100 may be accessed via the network 1044 by, for example, the terminals 1042, 1066. The eCRA system 100 may also access data from, for example, the server 1043 via the network 1044.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Also, it will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A radio-frequency (RF) waveguide comprising:
a pair of parallel rectangular waveguides including a first waveguide and a second waveguide; and
a mode converter coupled to respective ends of the pair of parallel rectangular waveguides, the mode converter comprising two coaxial cylinders.

2. The RF waveguide of claim 1, wherein a first waveguide of the pair of parallel rectangular waveguides is configured to feed microwaves from an RF source into the mode converter.

3. The RF waveguide of claim 1, wherein a second waveguide of the pair of parallel rectangular waveguides is coupled to an RF load.

4. The RF waveguide of claim 1, wherein the mode converter is configured to transform a radiation pattern into a rotating TE-11 coaxial mode between the two coaxial cylinders.

5. The RF waveguide of claim 1, wherein the mode converter comprises an outer body having at least a first transverse inward projection in an outer wall between one of the rectangular waveguides and an outer cylinder of the two coaxial cylinders.

6. The RF waveguide of claim 5, wherein the two coaxial cylinders of the mode converter extend axially past the outer body and the pair of parallel rectangular waveguides.

7. The RF waveguide of claim 5, wherein the outer body of the mode converter comprises an axial inward projection opposite the two coaxial cylinders.

8. An apparatus comprising:
a radio-frequency (RF) waveguide comprising:
a pair of parallel rectangular waveguides including a first waveguide and a second waveguide; and
a mode converter coupled to respective ends of the pair of parallel rectangular waveguides, the mode converter comprising and outer body and two coaxial cylinders;
an electron source configured to provide a beam of electrons; and
an accelerator including:
a RF cavity having a longitudinal axis, a cylindrical outer wall, an inlet, and an outlet;
an electro-magnet surrounding the RF cavity and configured to produce an axial magnetic field.

9. The apparatus of claim 8, wherein the inlet of the RF cavity is configured to receive the beam of electrons through an inner cylinder of the two coaxial cylinders.

10. The apparatus of claim 8, wherein the mode converter is configured to transform a radiation pattern into a rotating TE-11 coaxial mode between the two coaxial cylinders.

11. The apparatus of claim 8, wherein the mode converter is configured to excite a rotating TE-111 mode in the RF cavity.

12. The apparatus of claim 8, wherein a first waveguide of the pair of parallel rectangular waveguides is configured to feed microwaves from the RF source into the mode converter.

13. The apparatus of claim 8, wherein a second waveguide of the pair of parallel rectangular waveguides is coupled to an RF load.

14. The apparatus of claim 8, wherein the mode converter comprises at least a first transverse inward projection in an outer wall of the outer body between one of the rectangular waveguides and an outer cylinder of the two coaxial cylinders.

15. The apparatus of claim 8, wherein the two coaxial cylinders of the mode converter extend axially past the pair of parallel rectangular waveguides.

16. The apparatus of claim 8, wherein the outer body of the mode converter comprises an axial inward projection opposite the two coaxial cylinders.

17. The apparatus of claim 8, wherein the cylindrical outer wall of the RF cavity is free of openings.

18. A method, comprising:
feeding, via an RF waveguide, microwaves from an RF source into a mode converter comprising and outer body and two coaxial cylinders, the mode converter configured to transform a radiation pattern of the microwaves into a rotating TE-11 coaxial mode between the two coaxial cylinders;
exciting, by the mode converter, a rotating TE-111 mode in an RF cavity coupled to respective ends of the two coaxial cylinders;
generating an axial magnetic field in the RF cavity with a first magnet surrounding the RF cavity;
emitting a beam of electrons into the RF cavity through a passage within an inner cylinder of the two coaxial cylinders; and
accelerating the beam of electrons axially entering the RF cavity with non-linear cyclotron resonance acceleration.

19. The method of claim 18, further comprising manipulating the beam of electrons leaving the RF cavity into a desired beam shape with a second magnet.
